(19) United States
(12) Patent Application Publication
(10) Pub. No.: US 2010/0169941 A1
(43) Pub. Date: Jul. 1, 2010

(54) Method and Apparatus for Device-Independent Access to Multimedia Contents, and System Containing the Apparatus

(75) Inventors: Hermann Granzer, Pocking (DE); Joachim Meckel, Unterbiberg (DE)

Correspondence Address: LERNER GREENBERG STEMER LLP, P O BOX 2480, HOLLYWOOD, FL, 33022-2480, US

(73) Assignee: NOKIA SIEMENS NETWORKS OY, Espoo (FI)

(21) Appl. No.: 12/649,714

(22) Filed: Dec. 30, 2009

(30) Foreign Application Priority Data
Dec. 30, 2008 (EP) 08 106 038

(51) Int. Cl. H04N 7/173; G06F 15/16

(52) U.S. Cl. 725/88; 709/203; 709/201

(57) ABSTRACT

A method for device-independent access to multimedia contents is specified in which a marker information item is provided by a first terminal. The marker information contains at least one marker in a multimedia content. The marker information is stored and a request for access to the multimedia content is provided. A transmission information item is ascertained on the basis of the request for the purpose of transmitting the multimedia content starting from the at least one marker to a second terminal.

### CROSS-REFERENCE TO RELATED APPLICATION

This application claims the priority, under 35 U.S.C. §119, of European application EP 08106038, filed Dec. 30, 2008; the prior application is herewith incorporated by reference in its entirety.

### BACKGROUND OF THE INVENTION

1. Field of the Invention

The invention relates to a method and an apparatus for device-independent access to multimedia contents, and a system containing the apparatus.

Television and radio programs are increasingly being provided using a plurality of distribution channels. Thus, such programs are being provided by terrestrial antenna signal but also by cable networks, satellite systems, the Internet and communication networks, such as particularly mobile radio networks. More generally, these new distribution channels are being used to support multimedia services, which may contain not only television and audio programs but also video on demand, audio on demand, games, text, pictures, data and Internet access, for example.

In the case of Internet protocol television (IPTV), for example, broadband applications such as television programs and films are being transmitted digitally using a digital data network. This is also done using the Internet protocol (IP), on which the Internet is based. Typically, IPTV involves a telecommunication provider using a broadband network to provide a particular group of users, the subscribers, with a range of programs of a defined quality. Generally for technical reasons, IPTV requires the subscriber to have a suitable terminal approved by the IPTV provider. The terminal receives data streams via an Internet connection, e.g. DSL-based connection, splits these data streams into substreams (audio, video, data etc.), decodes them and generally delivers a picture and audio signal to an integrated or external video/audio output unit. The terminals available are, in particular, set top boxes (STB), television sets (TV), personal computers (PC) and mobile radios, for example. To provide the multimedia services relating to a respective IPTV range, the provider generally has components for control, load distribution and access control, for supplying television programs (TV head end) to the broadband network, for providing video/audio contents on demand (VoD server), for recording contents (PVRs), for transmitting by streaming and/or download and for encrypting the contents which are to be transmitted.

Beside IPTV network solutions based on a landline network, there are network solutions for mobile television which are suitable particularly for mobile radio networks and which are typically provided by mobile radio network operators, for example. Such solutions require similar components at the provider end, as already mentioned above, but use different concepts and standards as a result of different technology. In particular, the coding of the useful signals and the functionality of the terminals (e.g. display size, local processing power, local memory, transmission bandwidth), for example, are different than the IPTV solutions used for a landline network.

The plurality of distribution channels and network solutions means that it is possible for a user or subscriber to access a content which is of interest to him, for example a movie provided on demand or a television program, at home, at the workplace, at friends' houses or particularly on the move. To this end, the user or subscriber can use different terminals and/or can use different network solutions.

If the user interrupts access to the content and wishes to continue access to the content at a later time, he requires a way of easily getting to his last use of the content. By way of example, this can be done by offering or playing him the last music track that he listened to before an interruption when the interruption has ended. Similarly, the last opened page of an electronically accessible book or of an Internet presentation can be output following the interruption. Continuation of a movie provided on demand or a television program at the point of the interruption may also be desirable or take place. In addition, the user or subscriber may have defined individual information to simplify the orientation and/or access and the user or subscriber may likewise wish to continue to have the information available following the interruption.

A drawback in this case is that individual information linked to a content, particularly individual access information for the content, is not available across a plurality of different network solutions and in a device-independent manner.

### SUMMARY OF THE INVENTION

It is accordingly an object of the invention to provide a method and an apparatus for device-independent access to multimedia contents, and system containing the apparatus which overcome the above-mentioned disadvantages of the prior art methods and devices of this general type, which ensures that device-independent availability of individual information linked to a content is achieved efficiently and reliably.

The object is achieved by specifying a method for device-independent access to multimedia contents. the marker information item is provided by a first terminal, wherein the marker information contains at least one marker in a multimedia content. the marker information is stored and a request for access to the multimedia content is provided. A transmission information item is ascertained on the basis of the request for the purpose of transmitting the multimedia content starting from the at least one marker to a second terminal.

Hence, the marker information item, which contains the at least one marker in the multimedia content as an individual access information item for multimedia content, is provided by the first terminal. In the presence and on the basis of a request for access to the multimedia content, a transmission information item for transmitting a portion of the multimedia content which is linked to the at least one marker to the second terminal is automatically ascertained. In this case, it is advantageous that the at least one marker is stipulated by the first terminal and is employed or used for transmitting the multimedia content to the second terminal by virtue of the transmission information being ascertained such that transmission of the multimedia content starting from the at least one marker is achieved.

It is also advantageous that the transmission information is ascertained for the second terminal, even though the access information for the multimedia content is provided by the first terminal, which may be associated with another network solution and may have different device properties than the second terminal. Thus, the first terminal may be a landline television set top box, in particular. However, the request is taken as a basis for ascertaining a transmission information item for transmitting the multimedia content starting from the at least one marker for the second terminal, which may be a mobile terminal, for example, particularly a cell phone or mobile telephone, and hence may use a network solution for mobile radio television which may differ from the landline television solution in terms of transmission bandwidth, supported resolution, processing power of a terminal and/or transmission standard, for example.

By way of example, the multimedia content may be a television program, a video on demand, a radio broadcast, an audio on demand, an electronic game or an electronic book. Similarly, a multimedia content may contain a multimedia content which can be retrieved on demand by a subscriber, a movie, a video clip, a video message, a voice message, a recording of a television or radio program, a complete or partial recording of a television or radio program, an audio content, an Internet page, a walled garden page, picture material, sound material, a still picture, a moving picture, a live signal from a television or radio program, a link to one of the above contents, any combination of the above contents or any combination of the above contents with other contents.

By way of example, the method can be carried out in a server in an IPTV solution, a hybrid television solution based on terrestrial antenna or satellite antenna with a backward channel from the terminal to the service provider, a landline television solution based on DSL or cable connection, or a mobile radio television solution. Similarly, the method can be carried out on a network gateway node (gateway) between two of the aforementioned television solutions, particularly on a network gateway node between an IPTV solution in the landline network or a mobile radio television solution, for example. The method can also be carried out in a television solution based on terminals only, e.g. a peer-to-peer television solution.

One development is that the request relates to the at least one marker in the multimedia content or the request relates to the multimedia content starting from the at least one marker.

This means that the at least one marker, which is related to the multimedia content, can be requested. This is advantageous, for example if the transmission of the multimedia content starting from the at least one marker is still dependent on further states or events. Thus, by way of example, a charge information item, a network load, an overload in a network or a network node, a user information item regarding a rating or an assessment of the multimedia content, an information item regarding the length to be expected or the physical size of the multimedia content starting from the at least one marker, an access block for the second terminal or the subscriber using the second terminal may be the cause of a decision not to transmit the multimedia content starting from the at least one marker.

Should it be imperative for the multimedia content starting from the at least one marker to be reproduced, the request can relate to the multimedia content starting from the at least one marker directly. This is advantageous for reducing the number of messages required and an associated lower processing power in network nodes and a requesting device and also lower network loading.

Another development is that the transmission information contains a second coding for the second terminal which is different than a first coding for the first terminal.

In this context, first and second codings may be codings of the audio component and/or of the video component of the multimedia content which are suitable for the first and/or the second terminal or can be used exclusively therefor. Possible codings may be H.261, MPEG-1 Video, H.262, MPEG-2, H.263, MPEG-4 Visual, MPEG-4 AVC, MPEG-4 SVC, ABS, VC-1, MP2, MP3, AAC, AC-3 Dolby Digital, WMA, MLP, for example. In particular, the audio and video codings in landline television solutions (SDTV, HDTV) may be different than the codings used in the mobile radio television solutions. In this case, the first coding may differ from the second coding by virtue of the coding methods used for the audio and/or video stream of the multimedia content. Even if the same coding method is used for the first terminal and the second terminal, the first coding may differ from the second coding through the use of different coding parameters and/or settings for the coding device (encoder). Such settings may be a constant bit rate, a variable bit rate, a peak bit rate, an error correction method, a resolution for the video component of the multimedia content, an encryption information item or an encryption method, for example. The transmission information is ascertained such that information which determines the second coding is included. This means that it is advantageously possible to request the multimedia content starting from the at least one marker in the coding suitable for the second terminal.

The transmission information may likewise contain an address information item, particularly a frequency, multicast or unicast address for providing the multimedia content in the second coding, an address for the second terminal, an identification for the multimedia content, an access-control or rating information item for the second terminal and other transmission parameters.

Another development is that the transmission information and the at least one marker are made available to a server for providing the multimedia content starting from the at least one marker and on the basis of the second coding.

Typically, the server for providing the multimedia content starting from the at least one marker is a server which has stored the multimedia content in the memory. The fact that the server is provided with the transmission information and the marker means that it can provide the stored multimedia content starting from the at least one marker. If the format stored in the memory of the server already corresponds to the second coding, which is suitable for the second terminal, the provision may involve the mere reading of the stored content. In this case, the at least one marker is used by the server to determine the memory starting from which the multimedia content is to be reproduced. It is thus possible, by way of example, to perform a search for a picture, a frame, a sound sequence, a voice, a scene change, a relative time in order to find the location in the multimedia content which corresponds to the at least one marker.

If the relevant portion of the multimedia content is not already stored in the second coding in the memory of the server, the second coding can be produced dynamically by recoding in parallel with the reproduction or ahead of the reproduction. In this case, the recoding may be a function of the server or can be performed by a further transcoding device.

If there are a plurality of servers which have stored the multimedia content in their memory, the transmission information can preferably be provided by the server which has already stored the coding in its memory on the basis of the second identifier. Similarly, it is possible for the server to be selected on the basis of geographical aspects, for example a distance to the second terminal, on the basis of network loading, on the basis of a server utilization level, on the basis of a utilization level of a transmission channel in the network. This has the advantage of a favorable utilization level for the server or the servers and a favorable utilization level for network components which are needed for providing the multimedia content starting from the at least one marker.

The provision of the multimedia content starting from the at least one marker for the second terminal can be effected by a point-to-point or point-to-multipoint transmission. In particular, the provision of the multimedia content starting from the at least one marker can be effected by unicast, multicast or broadcast. If the provision is effected using multicast, broadcast, a frequency or a transmission method to be determined, it is additionally also possible to provide an address information item and/or a provision information item for the second terminal so that the terminal can also access the provided multimedia content starting from the at least one marker.

A further development is that the at least one marker is made available to a first PVR server for the purpose of recording the multimedia content starting from the at least one marker in the first coding.

It is therefore possible for a multimedia content disseminated by broadcast or multicast, particularly a live transmission, for example, to be recorded by the first PVR server starting from the at least one marker in the first coding, which is suitable for the first terminal. This has the advantage that a user can also use the first terminal to access the multimedia content starting from the at least one marker independently of and in addition to the second terminal. Recording in the first coding results in the further advantage that no recoding from the second coding to the first coding becomes necessary for provision of the multimedia content starting from the at least one marker for the first terminal.

It is also a development that the server is a VoD server and/or a second PVR server.

This is advantageous with regard to both a multimedia content provided individually upon demand and a multimedia content provided as a television program being able to be made available to the second terminal on the basis of the at least one marker. A multimedia content available on demand is preferably provided by a video on demand (VoD) server. If a multimedia content needs to be recorded starting from the at least one marker, this can preferably be done in the second personal video recorder (PVR) server. The second PVR server may be a recording device which is central to the network, but may also be a local function of the second terminal. The second PVR server may also be implemented in the interaction of a device which is central to the network and the second terminal. It is likewise advantageous if the functions of the VoD server and of the second PVR server are available in a single device, e.g. a device which is central to the network, since this allows an individual recording starting from the at least one marker, for example for television programs disseminated by broadcast or multicast which involve stored multimedia content, to be reduced to storage of the at least one marker.

A further development is that the at least one marker is made available to the second PVR server for the purpose of recording a multimedia content starting from the at least one marker in the second coding.

This allows a multimedia content processed using broadcast or multicast, particularly a live transmission, for example, to be recorded by the second PVR server starting from the at least one marker in the second coding, which is suitable for the second terminal. This has the advantage that a user can use the second terminal to access the multimedia content starting from the at least one marker independently of the first terminal. Recording in the second coding results in the further advantage that receipt of the request does not require recoding to the second coding.

Another development is that the marker information is provided at least for the second terminal.

Since the marker information is provided by the first terminal, this means that it is particularly also possible for the second terminal to get to know the marker information and hence the at least one marker. It is also possible for the marker information to contain further markers, for example, from which the second terminal can make a selection. This is advantageous in respect of a rapid overview of the available markers within the marker information and also a simple selection of the at least one marker from the marker information for the purpose of providing the multimedia content starting from the at least one marker.

The marker information may likewise contains markers for a plurality of multimedia contents. Thus, the second terminal can advantageously likewise make a selection from the available multimedia contents.

An additional development is that the marker information is provided on the basis of a first user input on the first terminal for the purpose of setting a marker in the multimedia content or for the purpose of stopping or terminating the output of the multimedia content.

This has the associated advantage that the user or subscriber can produce the marker information individually and explicitly. This can be done, by way of example, when a particularly exciting scene in a movie starts or a scene of little interest ends, which allows the at least one marker to be stipulated in the multimedia content. Similarly, the marker information may also contain a plurality of explicitly produced markers in the multimedia content.

If the user or subscriber terminates or interrupts the output of the multimedia content, this produces at least one additional marker which is contained in the marker information. This produces, advantageously automatically and without separate user input, a marker information item which enables the user or subscriber to be provided with the output of the multimedia content starting from the additional marker for the purpose of easily continuing the output of the multimedia content at the additional marker.

The first user input can particularly also be made by remote control of the first terminal.

A subsequent development is that the request is provided by the first terminal or by the second terminal.

This has the associated advantage that both the first and the second terminal are able to provide the request for access to the multimedia content. If a user or subscriber has followed the multimedia content as far as the at least one marker from his mobile terminal and reaches his residence, for example, he can make the request for access to the multimedia content starting from the at least one marker using the second terminal, whereupon the output of the multimedia content starting from the at least one marker is effected using the second terminal. Similarly, the user or subscriber can alternatively make the request for access to the multimedia content starting from the at least one marker using the first terminal, whereupon the output of the multimedia content starting from the at least one marker is effected using the second terminal. The user or subscriber therefore does not need to use the remote control of the second terminal, for example, in order to continue output of the multimedia content using the second terminal, but rather can use the first terminal, which he possibly holds in his hands anyway. This results in the additional advantage of simpler usability and almost immediate continuation of the output of the multimedia content using the second terminal.

A further refinement is that the request is provided on the basis of a second user input on the first terminal for the purpose of starting or continuing the multimedia content or on the basis of a third user input on the second terminal for the purpose of starting or continuing the multimedia content.

In this case, it is advantageous that the second or third user input can be used to access both explicitly produced markers and, within the context of interrupted output, implicitly produced markers.

The second user input can also be made by remote control of the first terminal. Similarly, the third user input can also be made by remote control of the second terminal.

It is likewise a development that the first terminal and the second terminal are associated with one another.

Such an association can, in principle, be made by a network operator or service provider, for example of landline television or of mobile radio television, by administrative means. Alternatively, it can be made by a user or subscriber himself if requisite functionality for this purpose is present in a network solution for landline television or mobile radio television.

By associating the first and second terminals with one another, it is possible to ensure that a second terminal cannot access the individual and, by way of example, personal marker information of the first terminal unintentionally or without authorization. It is likewise advantageously possible to prevent unintentional or unauthorized output of the multimedia content starting from the at least one marker to any second terminal. In particular, the association can be made by virtue of the first terminal and the second terminal being associated with a single subscriber, a single user or a particular group of users, for example all the members of a family.

The association can also be made by using an identifier for a user which is preferably protected, e.g. by a password. It is thus possible for any mobile radio, for example, as a second terminal, to be associated with a first terminal, e.g. a set top box. The association can also be made by inputting a first identifier on the first terminal and a second identifier on the second terminal, the first identifier and the second identifier being associated with one another or identical. In particular, the first and second identifiers may be associated with a single subscriber or user.

A further development is that the at least one marker contains a time value.

The time value may be a relative time from the start or the end of a television program or a movie. Similarly, the time value may be a relative time from another marker in the multimedia content. The time value may also relate to an absolute time, for example if the multimedia content is determined by a permanently transmitting monitoring camera or a landscape camera.

Since television transmissions and videos on demand which are present in the first coding and/or in the second coding generally already contain relative times, it is advantageously a simple matter, for example, to obtain the time value for an interruption from the useful data stream which is just before the output. Conversely, it is possible to continue the output following the interruption by ascertaining the frame which best corresponds to the time value obtained in this manner.

Other features which are considered as characteristic for the invention are set forth in the appended claims.

Although the invention is illustrated and described herein as embodied in a method and an apparatus for device-independent access to multimedia contents, and system comprising the apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a flowchart of fundamental method steps according to the invention;

FIG. 2 is a block diagram showing provision of a marker information item and a request for a multimedia content starting from the marker;

FIG. 3 is a block diagram showing provision of the marker information item and a request for the marker in a multimedia content;

FIG. 4 is a block diagram showing provision of the marker information item and the request for the marker by a first terminal;

FIG. 5 is a block diagram showing provision of the marker information item for a television program by a first terminal and a request for the television program on the basis of the marker information by a second terminal;

FIG. 6 is a block diagram showing provision of the marker information item for the television program by the first terminal, a central controller for two PVR servers and a request for the television program on the basis of the marker information by the second terminal;

FIG. 7 is an illustration showing a plurality of multimedia contents for a subscriber;

FIG. 8 is an illustration showing storage of a marker information item for a subscriber;

FIG. 9 is an illustration showing interruption of provision of a multimedia content in HDTV quality and continuation of the provision of the multimedia content in SDTV quality; and

FIG. 10 is an illustration showing continuation of provision of a multimedia content in HDTV quality and subsequent further continuation of the provision of the multimedia content in HDTV quality.

### DETAILED DESCRIPTION OF THE INVENTION

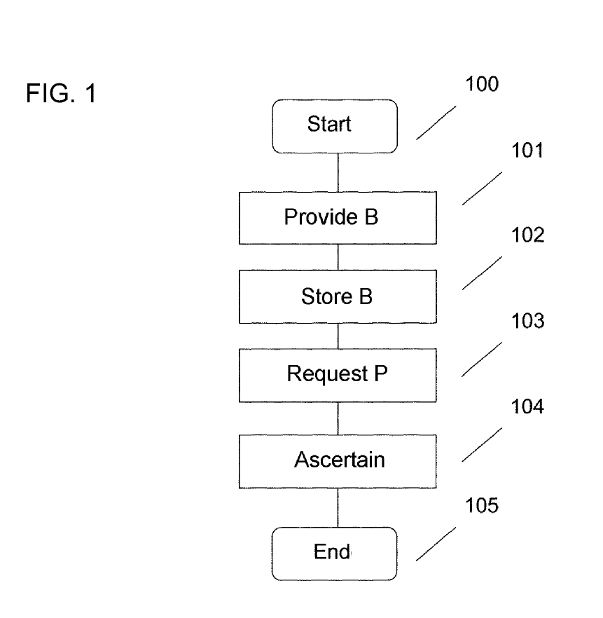

Referring now to the figures of the drawing in detail and first, particularly, to FIG. 1 thereof, there is shown a flowchart of fundamental method steps. Following a start (step 100), a marker information item B is first of all provided by a first terminal (step 101). The marker information B contains at least one marker in a multimedia content. Similarly, the marker information may contain a plurality of markers, for example, which may relate particularly to scenes or sections or general portions of the multimedia content.

The marker information B is then stored (step 102), and it is then available for later retrieval and evaluation. Further provision of further marker information in line with step 101 and further storage of the further marker information in line with step 102 are possible. In this case, the further marker information can complement, modify or erase the marker information B.

In step 103, a request P for access to the multimedia content is provided. In this case, the request P may relate to the provision of access information for the multimedia content. Similarly, the request P may also relate to the provision of the multimedia content itself. The request is typically made by a second terminal which wishes to have access to the multimedia content. The request P can likewise be provided by the first terminal, for example, by a further terminal or by a device in a mobile radio television solution or a landline television solution.

Following provision of the request P, step 104 involves the ascertainment of a transmission information item for the transmission of the multimedia content starting from the at least one marker. The information is ascertained on the basis of the request P and in respect of the provision of the multimedia content starting from the at least one marker for the second terminal. The transmission information may particularly contain coding which is suitable for the second terminal. In addition, an address for the second terminal, an address for a server which can provide the multimedia content starting from the at least one marker, and an identification for the multimedia content may be part of the transmission information.

The method ends in step 105.

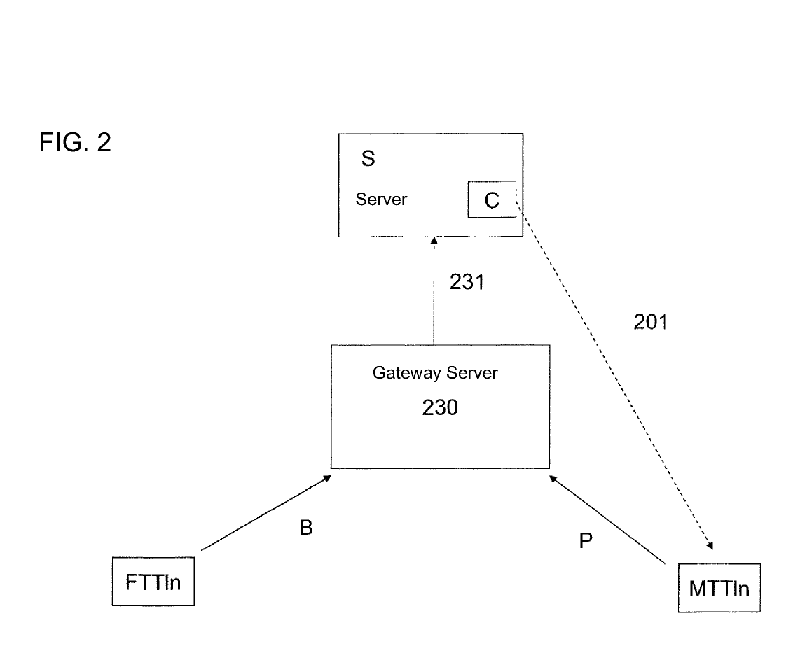

FIG. 2 shows provision of a marker information item B and a request P for a multimedia content C starting from a marker. A first terminal FTTIn in a landline television solution, for example a set top box which has access to a multimedia content C via a DSL connection, makes the marker information B available to a gateway server 230. The marker information B is transmitted in the form of a message from the first terminal FTTIn to the gateway server 230. The gateway server 230 stores the marker information B locally. The marker information B is preferably stored redundantly for reasons of fail-safety. By way of example, the marker information B contains a single marker in the multimedia content C. The multimedia content C is available on a server S in a coding which is suitable for a second terminal MTTIn. By way of example, the second terminal MTTIn is a mobile terminal which has access to mobile radio television. When the marker information B has been stored on the gateway server 230, the second terminal MTTIn generates a request P for the provision of the multimedia content C starting from the at least one marker. The request P is transmitted as a message to the gateway server 230. The latter then ascertains a transmission information item. This is done by evaluating the request P. In this way, the gateway server 230 learns that provision of the multimedia content C is required for a mobile radio in the mobile radio network solution. Possibly from a plurality of available video on demand servers, the gateway server 230 selects the server S which has the multimedia content C ready in a coding for the mobile radio network solution which is suitable for the second terminal MTTIn. In addition, geographical dependencies, load states of the mobile radio network or of the video on demand servers can be included in a decision for selecting the server S. Once the transmission information has been ascertained completely, the gateway server 230 sends the server S a message 231 according to which the server S demands provision of the multimedia content C starting from the at least one marker for the second terminal MTTIn. By way of example, the message may contain the at least one marker, an identification for the multimedia content C, a coding and setting parameters for an encoder, transmission parameters and/or an address for the second terminal FTTIn.

Following receipt of the message 231, the server S starts to provide the multimedia content C starting from the at least one marker for the second terminal. This can be done using a unicast method and by streaming, for example. The provision of the multimedia content C starting from the at least one marker is represented by a communication link 201.

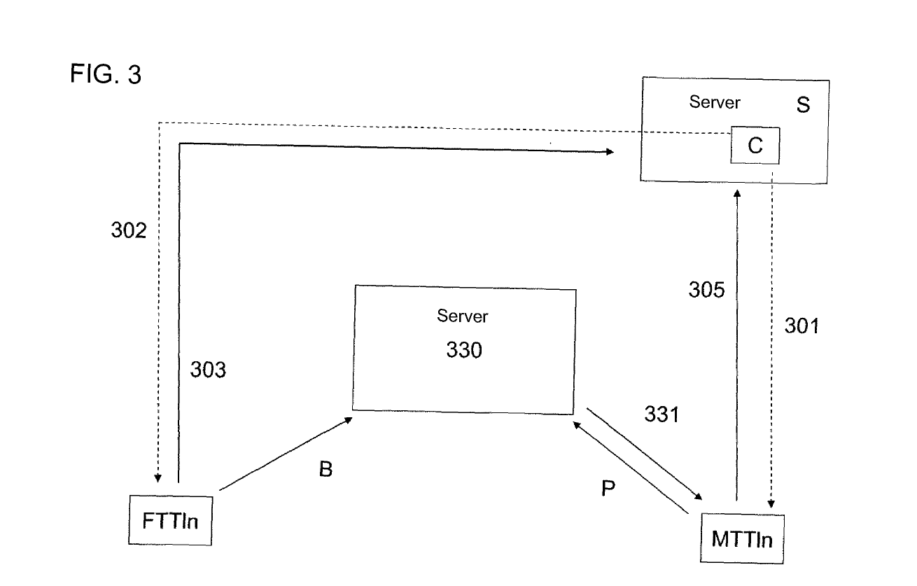

FIG. 3 shows provision of a marker information item B and a request P for a marker in a multimedia content C. A first terminal FTTIn in a landline television solution, for example a set top box, is provided with a multimedia content C, for example a movie available on demand, by a server S. This is shown by a communication link 302. A user of the first terminal FTTIn terminates the provision for example because he has to keep an appointment externally. On the basis of the termination of the provision of the multimedia content C, the first terminal FTTIn informs the server S by a message 303. The server S then terminates the provision of the multimedia content C for the first terminal. The first terminal FTTIn likewise sends the marker information B to a marker server 330. In this case, the marker information B is transmitted in the form of a message from the first terminal FTTIn to the marker server 330. The marker server 330 stores the marker information B locally. The marker information B is preferably stored redundantly for reasons of fail-safety. By way of example, the marker information B contains a single marker in the multimedia content C. The multimedia content C is available on a server S in a coding which is unsuitable for a second terminal MTTIn. However, the server S can perform dynamic recoding to a coding which is suitable for the second terminal MTTIn. By way of example, the second terminal MTTIn is a mobile terminal which has access to mobile radio television. When the marker information B has been stored on the marker server 330, the second terminal MTTIn generates a request P for the provision of the single marker in the multimedia content. The request P is transmitted as a message to the marker server 330. On the basis of the request P, the marker server provides the second terminal MTTIn with the single marker in the multimedia content. This is done in the form of a message 331. The second terminal MTTIn then ascertains a transmission information item. Possibility from a plurality of available video on demand servers, the second terminal MTTIn selects the server S which can provide the multimedia content C in the coding for the mobile radio television solution which is suitable for the second terminal MTTIn. In addition, geographical dependencies, load states of the mobile radio network or of the video on demand servers can be included in the selection decision of the second terminal MTTIn. Once the transmission information has been ascertained completely, the second terminal MTTIn sends the server S a message 305 according to which the server S demands the provision of the multimedia content C starting from the single marker for the second terminal MTTIn. By way of example, the message may contain the single marker in the multimedia content, an identification for the multimedia content C, a coding and setting parameters for an encoder, transmission parameters and/or an address for the second terminal MTTIn. Following receipt of the message 305, the server S starts to provide the multimedia content C for the second terminal NTTIn starting from the single marker. Since the server S has not stored the coding which is suitable for the second terminal in the memory, the server S uses a local recoding function, for example, to generate the coding which is suitable for the second terminal. The provision of the multimedia content C starting from the single marker for the second terminal MTTIn can be effected using the unicast method and by streaming, for example. The provision of the multimedia content C starting from the at least one marker is represented by a communication link 301.

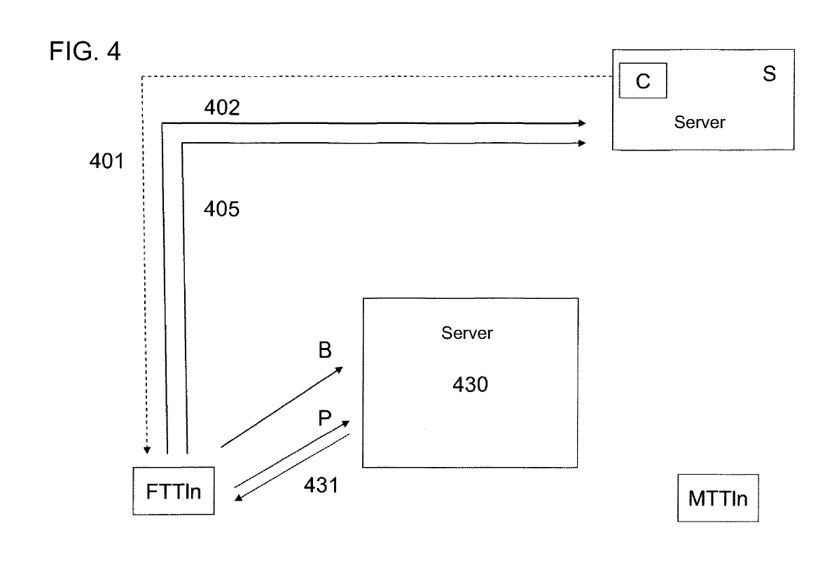

FIG. 4 shows provision of a marker information item B and a request P for a marker by a first terminal FTTIn. The first terminal FTTIn in a landline television solution, for example a set top box, is provided with a multimedia content C, for example a movie available on demand, by a server S. This is shown by a communication link 401. A user of the first terminal FTTIn interrupts the provision for example because he receives a call. On the basis of the interruption in the provision of the multimedia content C, the first terminal FTTIn informs the server S by of a message 402. The server S then terminates the provision of the multimedia content C for the first terminal FTTIn. The first terminal FTTIn likewise sends a marker information item B to a marker server 430. In this case, the marker information B is transmitted in the form of a message from the first terminal FTTIn to the marker server 430. The marker server 430 stores the marker information B locally. The marker information B is preferably stored redundantly for reasons of fail-safety. By way of example, the marker information B contains a single marker in the multimedia content C. When the marker information B has been stored on the marker server 430, the first terminal FTTIn generates a request P for provision of the at least one marker. The request P is transmitted as a message to the marker server 430. On the basis of the request P, the marker server provides the first terminal FTTIn with the at least one marker. This is done in the form of a message 431. The first terminal FTTIn then ascertains a transmission information item. Possibly from a plurality of available video on demand servers, the first terminal FTTIn selects the server S which can provide the multimedia content C in a coding for the landline television solution which is suitable for the first terminal FTTIn. In addition, geographical dependencies, load states of the landline network or of the video on demand servers can be included in the selection decision of the first terminal FTTIn. When the transmission information has been ascertained completely, the first terminal FTTIn sends the server S a message 405 according to which the server S demands the provision of the multimedia content C starting from the at least one marker for the first terminal FTTIn. By way of example, the message may contain the at least one marker, an identification for the multimedia content C, a coding and setting parameters for an encoder, transmission parameters and/or an address for the first terminal FTTIn. Following receipt of the message 405, the server S starts to provide the multimedia content C starting from the at least one marker for the first terminal FTTIn. The provision of the multimedia content C starting from the at least one marker for the first terminal FTTIn can be effected using the unicast method and by streaming, for example. The provision of the multimedia content C starting from the at least one marker is represented by the communication link 401.

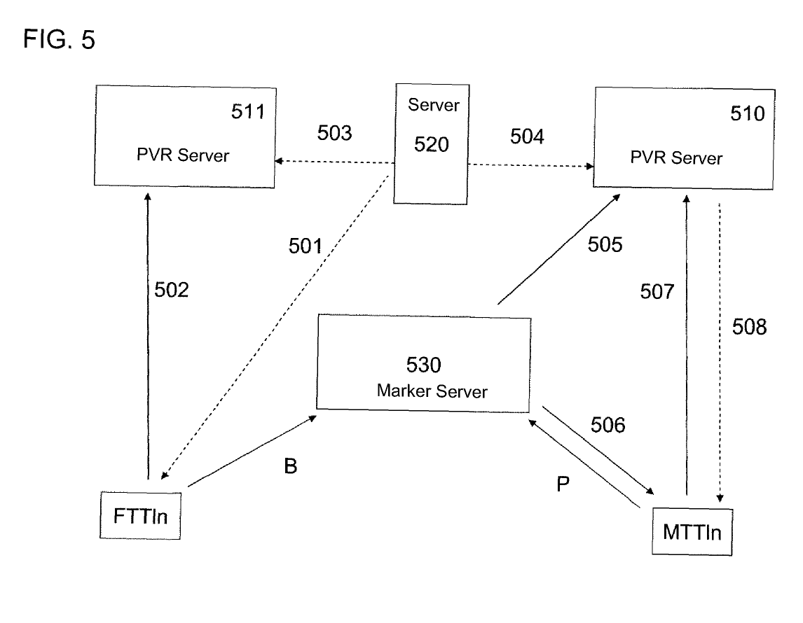

FIG. 5 shows provision of a marker information item B for a television program by a first terminal FTTIn and a request P for the television program in line with the marker information B by a second termainl MTTIn. The first terminal FTTIn in a landline television solution, for example a set top box, is provided with a multimedia content, for example a television transmission on a television channel, by a TV head end server 520. This is shown by a communication link 501. A user of the first terminal FTTIn terminates the provision for example because he has to keep an appointment externally. On the basis of the termination of the provision of the multimedia content, the first terminal FTTIn sends a marker information item B to a marker server 530. In this case, the marker information B is transmitted in the form of a message from the first terminal FTTIn to the marker server 530. The marker server 530 stores the marker information B locally. The marker information B is preferably stored redundantly for reasons of fail-safety. By way of example, the marker information B contains a single marker in the multimedia content. Upon the termination of the provision of the multimedia content, the first terminal FTTIn sends a message 502 to a first PVR server 511 according to which the first PVR server 511 is prompted to record the multimedia content starting from the single marker in a coding which is suitable for the first terminal FTTIn. On the basis of the message 502, the first PVR server 511 switches to the television program which is provided by the TV head end server 520 in the coding which is suitable for the first terminal FTTIn, and records the multimedia content in the form of the television transmission starting from the single marker. The transmission of the multimedia content from the TV head end server 520 to the first PVR server 511 is represented by a communication link 503. Upon receipt of the marker information B, the marker server 530 sends a message 505 to a second PVR server 510 according to which the second PVR server 510 is prompted to record the multimedia content starting from the single marker in a coding which is suitable for the second terminal MTTIn. On the basis of the message 505, the second PVR server 510 switches to the television program which is provided by the TV head end server 520 in the coding which is suitable for the second terminal MTTIn, and records the multimedia content in the form of the television transmission starting from the single marker. The transmission of the multimedia content from the TV head end server 520 to the second PVR server 510 is represented by a communication link 504. By way of example, the second terminal MTTIn is a mobile terminal which has access to mobile radio television. When the marker information B has been stored on the marker server 530, the second terminal MTTIn generates a request P for provision of the at least one marker. The request P is transmitted as a message to the marker server 530. On the basis of the request P, the marker server 530 provides the second terminal MTTIn with the single marker. This is done in the form of a message 506. Furthermore, the message 506 may contain an address information item for the second PVR server 510. The second terminal MTTIn then ascertains a transmission information item. When the transmission information has been ascertained completely, the second terminal MTTIn sends the second PVR server 510 a message 507 according to which the second PVR server 510 demands the provision of the multimedia content starting from the single marker for the second terminal MTTIn. By way of example, the message may contain the single marker, an identification for the multimedia content, a coding and setting parameters for an encoder, transmission parameters and/or an address for the second terminal MTTIn. Following receipt of the message 507, the second PVR server 510 starts to provide the multimedia content C starting from the single marker for the second terminal MTTIn. The provision of the multimedia content starting from the single marker for the second terminal MTTIn can be effected using the unicast method and by streaming, for example. The provision of the multimedia content starting from the single marker is represented by a communication link 508.

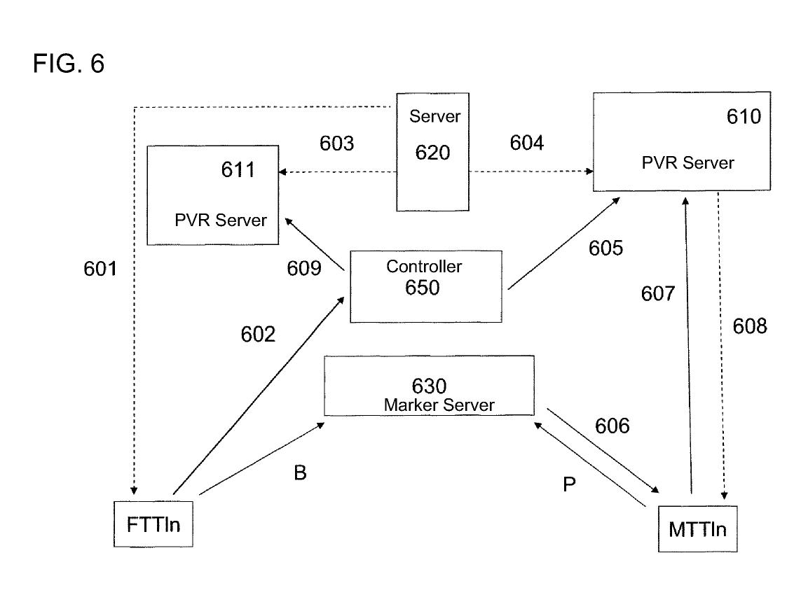

FIG. 6 shows provision of a marker information item B for a television program by a first terminal FTTIn, a central controller 650 for two PVR servers and a request P for the television program on the basis of the marker information by a second terminal MTTIn. The first terminal FTTIn in a landline television solution, for example a set top box, is provided with a multimedia content, for example a television transmission on a television channel, by a TV head end server 620. This is shown by a communication link 601. A user of the first terminal FTTIn terminates the provision for example because he has to keep an appointment externally. On the basis of the termination of the provision of the multimedia content, the first terminal FTTIn sends a marker information item B to a marker server 630. In this case, the marker information B is transmitted in the form of a message from the first terminal FTTIn to the marker server 630. The marker server 630 stores the marker information B locally. The marker information B is preferably stored redundantly for reasons of fail-safety. By way of example, the marker information B contains a single marker in the multimedia content. Upon termination of the provision of the multimedia content, the first terminal FTTIn sends a message 602 to the central controller 650. The central controller 650 checks whether an order for recording of the television program in a coding which is suitable for the first terminal FTTIn has already been received. If this is not the case, the central controller 650 sends the first PVR server 611 a message 609 according to which the first PVR server 611 is prompted to record the multimedia content starting from the single marker in a coding which is suitable for the first terminal FTTIn. Otherwise, the central controller 650 notes that recording of the multimedia content C starting from the single marker has been demanded by the first terminal FTTIn. On the basis of the message 609, the first PVR server 611 switches to the television program which is provided by the TV head end server 620 in the coding which is suitable for the first terminal FTTIn, and records the multimedia content in the form of the television transmission starting from the single marker. The transmission of the multimedia content for the TV head end server 620 to the first PVR server 611 is represented by a communication link 603. Upon receipt of the message 602, the central controller 650 also checks whether an order for recording of the television program in a coding which is suitable for the second terminal MTTIn has already been received. If this is not the case, the central controller 650 sends a second PVR server 610 a message 605 according to which the second PVR server 610 is prompted to record the multimedia content starting from the single marker in a coding which is suitable for the second terminal MTTIn. Otherwise, the central controller 650 notes that recording of the multimedia content C starting from the single marker has been demanded for the second terminal MTTIn. On the basis of the message 605, the second PVR server 610 switches to the television program which is provided by the TV head end server 620 in the coding which is suitable for the second terminal MTTIn, and records the multimedia content C in the form of the television transmission starting from the single marker. The transmission of the multimedia content C from the TV head end server 620 to the second PVR server 610 is represented by a communication link 604. By way of example, the second terminal MTTIn is a mobile terminal which has access to mobile radio television. When the marker information B has been stored on the marker server 630, the second terminal MTTIn generates a request P for provision of the single marker. The request P is transmitted as a message to the marker server 630. On the basis of the request P, the marker server 630 provides the second terminal MTTIn with the single marker. This is done in the form of a message 606. An address information item for the second PVR server 610 may be contained in the configuration data of the second terminal MTTIn. Similarly, the address information for the second PVR server 610 may be provided by the second terminal MTTIn by interrogating the central controller 650, for example. The second terminal MTTIn then ascertains a transmission information item. When the transmission information has been ascertained completely, the second terminal MTTIn sends the second PVR server 610 a message 607 according to which the second PVR server 610 demands the provision of the multimedia content starting from the single marker for the second terminal MTTIn. By way of example, the message may contain the single marker, an identification for the multimedia content, a coding and setting parameters for an encoder, transmission parameters and/or an address for the second terminal MTTIn. Following receipt of the message 607, the second PVR server 610 starts to provide the multimedia content starting from the single marker for the second terminal MTTIn. The provision of the multimedia content starting from the at least one marker for the second terminal MTTIn can be effected using the unicast method and by streaming, for example. The provision of the multimedia content starting from the at least one marker is represented by a communication link 608.

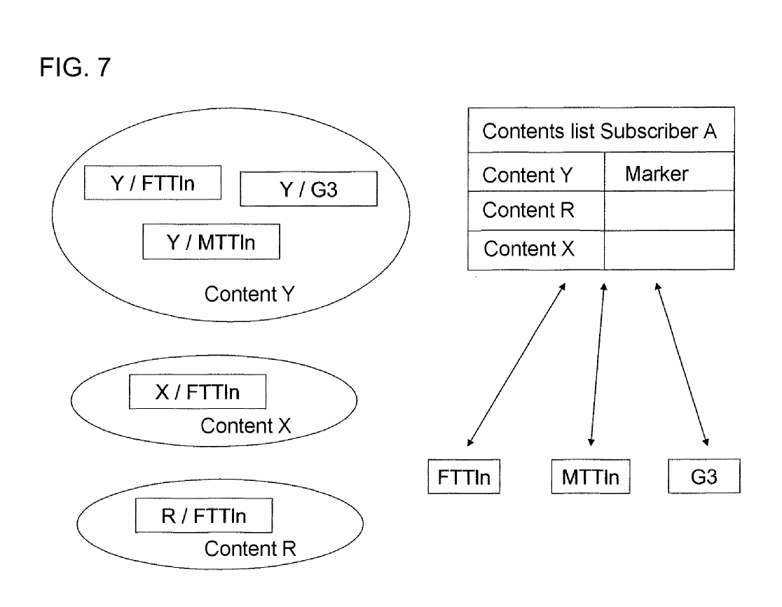

FIG. 7 shows a plurality of multimedia contents for a subscriber A. The subscriber A uses a personal contents list. By way of example this contains a plurality of movies and/or other multimedia contents which the subscriber has purchased or rented. The subscriber uses a first terminal FTTIn in a landline television solution, a second terminal MTTIn in a mobile radio television solution and a further terminal G3 in a further television solution. A multimedia content X and a multimedia content R are available only in a version which is suitable for the first terminal FTTIn. A multimedia content Y is respectively available in a version which is suitable for each of the terminals of the subscriber. For the multimedia content Y, a global marker is available which is stored in the personal contents list.

In the simplest case, the subscriber can have only one marker per multimedia content, the marker being used to mark stopping or termination of provision of a multimedia content and being able to be used to continue the provision of the multimedia content.

Similarly, a multimedia content may have one marker per terminal (e.g. TV, STB, mobile telephone), per location (e.g. living room, child's room, office, car), per user (e.g. family member), per further parameter (e.g. weekday).

In particular, if there are a plurality of markers for a multimedia content, a marker can be selected automatically. If, by way of example, a marker M1 is set during the output of a multimedia content in HDTV quality, this may be different than a marker M2 during the output of the multimedia content in SDTV quality. When the output in HDTV is continued, it is possible to automatically access the marker M1 to continue the output in HDTV quality, for example.

Markers can be output to the subscriber or to a user on a graphical user interface of a terminal. Advantageously, the clarity of the output can be increased by using parameter-based contents lists or different types of markers.

The subscriber or user can also have a plurality of markers per multimedia content. Similarly, a multimedia content may have a plurality of parameter-specific markers available (HDTV1, HDTV2, Mobile1, SDTV1, Mobile2, Mobile3, TVSET, child's room).

Markers can preferably be used on a terminal-specific basis, so that, upon continuation of the output of a multimedia content using a terminal, the marker which exists for this terminal is used. In addition to such a default, however, the user can also be provided with the option of using a marker from another terminal to continue the output of the multimedia content. Alternatively, instead of the terminal, it is also possible to use another parameter (living room, child's room, office, car) to select a marker. In this case, the selection can be made automatically or by the subscriber or user.

Similarly, the subscriber or the user can use a plurality of markers in order to flag a respective start of scenes of interest in a movie, for example. By accessing the plurality of markers, these scenes can easily be viewed later. These scene-based markers may preferably be identical for all terminals FTTIn, MTTIn and G3 of the subscriber or user, since they are respectively linked to a time value which may be independent of an output on an HDTV-compatible terminal, an SDTV-compatible terminal or a mobile terminal. These markers are each device-independent and denote a respective identical time in the movie.

It is likewise possible for a service provider, particularly a network operator, a content provider, an external service provider, a public Internet service provider, to predefine markers for a multimedia content. By way of example, the most spectacular stunt scenes may already have markers present which the service provider has provided using a first terminal, for example. The service provider can store a plurality of such markers in a further marker list and can make them available to the subscriber or user. If the subscriber or user wishes to make use of such markers, the subscriber or user can copy, accept or import the further marker list into his personal marker list. It is therefore possible for the subscriber or user to be provided with predefined scene-based markers which he can use, alter and add to.

When the subscriber or user has stored a scene-based marker, for example, he can make the marker available or export it for a further subscriber or user. This can be done using a public Internet service or a service from the service provider, for example. The further subscriber or user can import the scene-based marker. Similarly, the further subscriber or user can be provided with the option of accepting the scene-based marker into his personal marker list when the further subscriber or user purchases the movie, rents it or borrows it for the first time, for example.

When predefined markers from the service provider or markers from the further subscriber are used, the personal marker list for the subscriber or user may have a plurality of markers which may be real time values in the movie. In particular, the predefined markers and/or the markers from the further subscriber may also be device-specific markers or parameter-based markers.

To simplify handling, the service provider, the subscriber or user or the further subscriber or user provide markers with a name. By way of example, scene-based markers in a soccer game can be denoted by “whistle”, “second half', “1:0” or “penalty”.

Similarly, markers may be dependent on one another, for example by denoting a start of a scene and an end of the scene (start-stop) or by denoting a start, a first highlight and an end of a scene (start-highlight-stop), for example. There may thus be pairs, triples or n-tuples of mutually dependent or mutually associated markers in the personal marker list of the subscriber or user for a multimedia content. If the subscriber or user wishes to see only the highlights of a soccer game or only the funniest scenes in a comedy, for example, the subscriber or user can make use of a marker list which contains only start-stop marker pairs, for example. When such a marker list is available, the subscriber or user can advantageously save local memory space, bandwidth and/or transmission time if he relates a request for the multimedia content to this list and not just to a marker in the list. He is therefore able to prompt only the series of highlights being provided for him by a loading process or by streaming. A memory space saving is obtained in this case only if the subscriber or user stores the portion of the multimedia content which is determined by the marker list locally, particularly using a Push VoD method, or if he wishes to record the portion of the multimedia content which is provided by streaming locally.

Besides start-stop marker pairs, which allow an already stored multimedia content to be requested with unwanted components omitted, a multimedia content may also have respective markers for the start and end of the multimedia content.

It is also possible for markers in a multimedia content to be provided with access control information. By way of example, the service provider may have predefined or parents may have set an access control information item “suitable for six years and upwards” for a first time period in a multimedia content. By contrast, another time period, for example scene of violence, may be denoted by markers which have a “suitable for 12 years and upwards” access control information item. If the multimedia content is now requested by a second terminal for which there is a restriction to suitability for six years and upwards, the access control information is factored in when ascertaining the transmission information. This reduces a request for the entire multimedia content to reproduction of the sections which are permitted on the basis of access control information taking account of the marker list. An explicit request for provision of the multimedia content starting from a marker which is inadmissible on the basis of access control information can be denied or can result in the multimedia content being continued starting from the next admissible marker on the basis of access control information.

Output of markers for a multimedia content may advantageously—in respect of use—be extended by a marker type. A name, time value and type, particularly start marker, end marker, device marker, parameter marker, admission control marker, can be output to the subscriber or user. In this case, horizontal or vertical overviews and/or lists with the entire marker information or with portions thereof can be provided as outputs.

A multimedia content can be coded by a content provider or a content distributor, for example an IPTV provider, offline, i.e. in a preprocessing step. In this case, the multimedia content can be provided by the content owner, for example a Hollywood studio, in high quality on a magnetic tape. An encoder can be used to put the multimedia content into one of the codings MPEG2, H.264, VC1, for example, and optionally to encrypt it, e.g. using one of the methods AES, CSA or a proprietary encryption method.

Similarly, a subscriber or user can produce his own multimedia content, for example by recording a content provided by a broadcast or using suitable recording devices, for example a camera and/or a microphone.

If a multimedia content is intended to be made available both to a landline television solution and to a mobile radio television solution, it may be that the multimedia content needs to be available in HDTV and SDTV quality for terminals in the landline television solution and in H.263 coding, H.264 coding or MPEG coding at low resolution for terminals in the mobile radio television solution, for example. It may be necessary for the multimedia content to be available in different versions, which may be different terms of format, coding method, resolution or encryption.

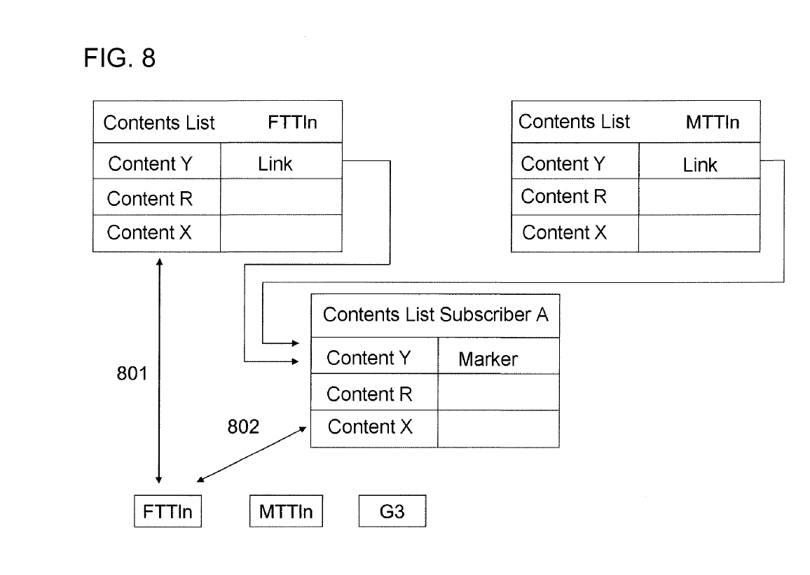

FIG. 8 shows storage of a marker information item for a subscriber A. The subscriber A uses a personal contents list. By way of example, the list contains a plurality of movies and/or other multimedia contents. The subscriber uses a first terminal FTTIn in a landline television solution, a second terminal MTTIn in a mobile radio television solution and a further terminal G3 in a further television solution. The first and the second terminal have a respective device-specific contents list.

The first terminal FTTIn has access to multimedia contents Y, R and X. For the multimedia content Y, there is a marker in the device-specific contents list of the first terminal FTTIn, and for the multimedia contents R and X, there are no markers. Since the multimedia content Y can also be accessed by the second terminal MTTIn, the marker is stored in a central contents list. The device-specific contents list of the first terminal FTTIn has a link to the marker stored in the central contents list.

The second terminal MTTIn likewise has access to the multimedia contents Y, R and X. For the multimedia content Y, there is a marker in the device-specific contents list of the second terminal MTTIn, and for the multimedia contents R and X, there are no markers. Since the multimedia content Y can also be accessed by the first terminal FTTIn, the marker is stored in a central contents list. The device-specific contents list of the second terminal MTTIn has a link to the marker stored in the central contents list.

The central contents list is preferably stored at a central location. Both the first terminal FTTIn and the second terminal MTTIn have access to the central contents list. Device-specific contents lists and also central contents lists may be stored in XML format and/or in a database.

The current markers which are available to the first terminal FTTIn are retrieved by data access 801 to the device-specific contents list of the first terminal FTTIn. The first terminal FTTIn can take the check on its device-specific contents list as a basis for outputting to the subscriber or user all markers currently available from the first terminal in the multimedia contents Y, R and X. To output the marker in the multimedia content Y, it is additionally necessary to access the global contents list in line with a read data access operation 802.

If the first terminal is intended to be used to create a further marker in the multimedia content Y, this is done solely by entering the further marker in the central contents list in line with a write data access operation 802.

The markers for the multimedia content Y which are available to the first terminal FTTIn and/or to the second terminal MTTIn can be requested in different ways. It is thus possible to make a selection from a list, for example, which is displayed as an overlay or in full-frame mode. Similarly, it is possible for markers which are present to be visually displayed on a time axis or in the form of a clock, the time axis and the clock being linked to the temporal length of the multimedia content Y. If the alternatives presented above are avoided, it is possible to skip directly to the next or to the preceding marker using suitable remote control inputs for the first and the second terminal FTTIn, MTTIn.

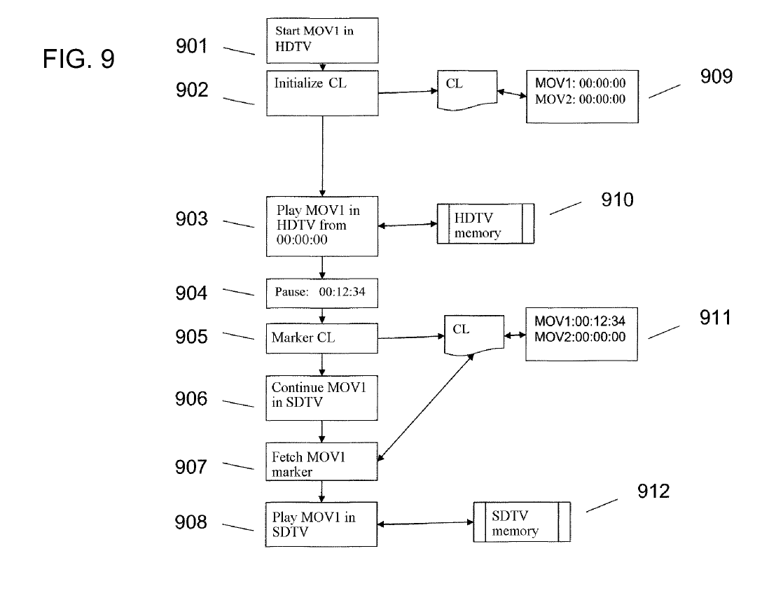

FIG. 9 shows interruption of provision of a multimedia content MOV1 in HDTV quality and continuation of the provision of the multimedia content MOV1 in a SDTV quality. In step 901, the multimedia content MOV1, which is a movie, is started for the first time in HDTV quality. The movie MOV1 is provided on demand. In step 902, a contents list CL is initialized. MOV1 is accepted into the contents list CL with the marker 0 hours, 0 minutes, 0 seconds. This is shown by a table 909. In step 903, the movie MOV1 is provided starting from the marker 0 hours, 0 minutes, 0 seconds. The movie is provided by reading from a memory 910 which store MOV1 in HDTV coding. In step 904, the provision of MOV1 in HDTV quality is interrupted at the time 0 hours, 12 minutes, 34 seconds. This may have been caused by a subscriber or user using a pause key on a remote control of a first terminal, for example. In step 905, the interruption is stored as a marker in the contents list CL. This is shown by a table 911. MOV1 is updated in the contents list CL with the marker 0 hours, 12 minutes, 34 seconds. In step 906, provision of MOV1 is continued in SDTV quality. This may have been caused by the subscriber or user using a continuation key (resume) on the remote control of a second terminal, for example. Step 907 effects read access to the marker in the movie MOV1 in the contents list CL. The provision of the movie MOV1 in SDTV quality starting from the marker is effected in step 908 by reading from a memory 912 which stores MOV1 in SDTV coding.

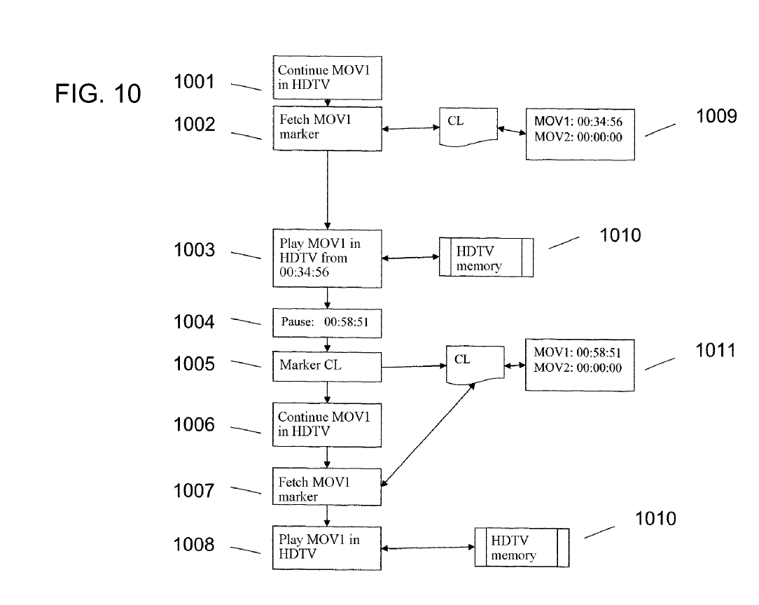

FIG. 10 shows continuation of provision of a multimedia content MOV1 in HDTV quality and subsequent further continuation of the provision of the multimedia content MOV1 in HDTV quality. In step 1001, the provision of the multimedia content MOV1, which is a movie, is continued in HDTV quality. This may have been caused by a subscriber or user using a continuation key (resume) on a remote control of a second terminal, for example. Step 1002 effects read access to a marker in the movie MOV1 in a contents list CL. The marker is read with 0 hours, 34 minutes and 56 seconds. The marker is stored in a table 1009, which is part of the contents list CL. Provision of the movie MOV1 in HDTV quality starting from the marker is effected in step 1003 by reading from a memory 1010, which stores MOV1 in HDTV coding. In step 1004, the provision of the MOV1 in HDTV quality is interrupted at the time 0 hours, 58 minutes, 51 seconds. This may have been caused by the subscriber or user using a pause key on the remote control of the second terminal, for example. In step 1005, the interruption is stored as a marker in the contents list CL. The marker in the movie MOV1 is updated in the contents list CL with the marker 0 hours, 58 minutes, 51 seconds. This is shown by a table 1011. In step 1006, the provision of MOV1 is continued in HDTV quality. This may been caused by the subscriber or user using the continuation key (resume) on the remote control of the second terminal, for example. Step 1007 effects read access to the marker in the movie MOV1 in the contents list CL. Provision of the movie MOV1 in HDTV quality starting from the marker is effected in step 1008 by reading from the memory 1010, which stores MOV1 in HDTV coding.

1. A method for device-independent access to multimedia contents, which comprises the steps of:
providing, via a first terminal, a marker information item containing at least one marker for a multimedia content;
storing the marker information item;
providing a request for access to the multimedia content; and
ascertaining, on a basis of the request, a transmission information item for transmitting the multimedia content starting from the at least one marker to a second terminal.

2. The method according to claim 1, wherein the request relates to the at least one marker in the multimedia content.

3. The method according to claim 1, which further comprises setting up the transmission information item to contain a second coding for the second terminal which is different than a first coding for the first terminal.

4. The method according to claim 3, which further comprises making available the transmission information item and the at least one marker to a server for providing the multimedia content starting from the at least one marker and on a basis of the second coding.

5. The method according to claim 3, which further comprises making the at least one marker available to a first personal video recorder (PVR) server for recording the multimedia content starting from the at least one marker in the first coding.

6. The method according to claim 4, which further comprises selecting the server from the group consisting of a video on demand server, a personal video recorder server, and a video on demand and personal video recorder server.

7. The method according to claim 6, which further comprises making at least one marker available to the PVR server for recording the multimedia content starting from the at least one marker in the second coding.

8. The method according to claim 1, which further comprises providing the marker information item at least for the second terminal.

9. The method according to claim 1, which further comprises providing the marker information item on a basis of a first user input on the first terminal for one of setting the marker in the multimedia content, stopping an output of the multimedia content, and terminating an output of the multimedia content.

10. The method according to claim 1, wherein the request is provided by one of the first terminal and the second terminal.

11. The method according to claim 1, wherein the request is provided on a basis of a second user input on the first terminal for the purpose of starting or continuing the multimedia content or on the basis of a third user input on the second terminal for the purpose of starting or continuing the multimedia content.

12. The method according to claim 1, wherein the first terminal and the second terminal are associated with one another.

13. The method according to claim 1, wherein the at least one marker contains a time value.

14. The method according to claim 1, wherein the request relates to the multimedia content starting from the at least one marker.

15. An apparatus for device-independent access to multimedia contents, the apparatus comprising:
a processor unit; and
an at least partially hardwired circuit configuration programmed to:
provide, via a first terminal, a marker information item containing at least one marker in a multimedia content;
store the marker information item;
provide a request for access to the multimedia content; and
ascertain, on a basis of the request, a transmission information item for transmitting the multimedia content starting from the at least one marker to a second terminal.

16. A system, comprising:
an apparatus for device-independent access to multimedia contents, said apparatus including a processor unit and an at least partially hardwired circuit configuration programmed to:
provide, via a first terminal, a marker information item containing at least one marker in a multimedia content;
store the marker information item;
provide a request for access to the multimedia content; and
ascertain, on a basis of the request, a transmission information item for transmitting the multimedia content starting from the at least one marker to a second terminal.

17. The system according to claim 16, wherein the system is a communications system.
